(19) United States
(12) Patent Application Publication
(10) Pub. No.: US 2023/0088423 A1
(43) Pub. Date: Mar. 23, 2023

(54) Control System with Safe Input

(71) Applicant: ABB Schweiz AG, Baden (CH)

(72) Inventors: Thomas Ewald, Worms (DE); Peter Gehring, Speyer (DE); Andreas Buening, Maxdorf (DE); Benjamin Maier, Hirschberg (DE); Yauheni Veryha, Mannheim (DE)

(73) Assignee: ABB Schweiz AG, Baden (CH)

(21) Appl. No.: 17/946,851

(22) Filed: Sep. 16, 2022

(30) Foreign Application Priority Data
Sep. 20, 2021 (DE) 202021105053.5

(51) Int. Cl. G05B 19/4155

(52) U.S. Cl. CPC G05B 19/4155; G05B 2219/36133

(57) ABSTRACT

A control system configured for safe input, visualization and/or communication for controlling a machine, includes a display device configured to display at least one symbol, an optical input device configured to detect, from the display device, at least a portion of the symbol, a redundant communication system configured to send the symbol, and a control unit configured to send the symbol and a test sequence to the display device, receive the symbol and the test sequence from the display device, test at least the test sequence, and, if the check sequence is correctly received, generate a redundant encoding of the symbol and send the redundantly encoded symbol over a redundant network.

### CROSS-REFERENCE TO RELATED APPLICATIONS

This patent application claims priority to German Patent Application No. 202021105053.5, filed on Sep. 20, 2021, which is incorporated herein in its entirety by reference.

### FIELD OF THE DISCLOSURE

The present disclosure relates to a control system with a safe Human Machine Interface (safe HMI), in particular with a safe input, for control systems of functional safety in factory and process automation.

### BACKGROUND OF THE INVENTION

Control systems are used to control processes and/or plant components, for example to control a machine. Control systems comprise at least one control device and at least one human-machine interface (HMI). For at least some types of machines, processes, or plant components, a control system may be required to control safety-critical and non-safety-critical processes and/or plant components. Control devices for controlling safety critical and non-safety critical processes and/or plant components are known. For example, EP 2504739 B1 shows such a control device for controlling safety-critical and non-safety-critical processes and/or plant components. For at least some types of machines, processes or plant components, a safe human-machine interface (safe HMI), in particular a safe input, may be useful and/or required.

### BRIEF SUMMARY OF THE INVENTION

There may be a desire to provide a control system for controlling processes and/or plant components with safe Human Machine Interface (safe HMI), in particular safe input. In particular, there may be a desire to provide a control system for controlling safety-critical and non-safety critical processes and/or plant components with safe Human Machine Interface (safe HMI), in particular safe input.

One aspect of the present disclosure relates to a control system configured for fail-safe input, visualization and/or communication for controlling a machine. The control system comprises a human-machine interface (HMI). The HMI has a display device for displaying at least one symbol; the symbol displayed or shown by the display device may include, for example, letters, numbers, graphics, buttons, etc. Further, the HMI comprises an optical input device configured to detect, from the display device, at least a portion of the symbol. Further, the control system comprises a redundant communication system configured to send the symbol; further, the control system comprises a control device. The control device is configured to control processes and/or plant components, and to send the symbol and a check sequence to the HMI, in particular the display device, to receive the symbol and the check sequence from the HMI, the display device, check at least the check sequence, and, if the check sequence is correctly received, generate a redundant encoding of the symbol and send the redundantly encoded symbol over a redundant network.

Alternatively or additionally, the control system with safe HMI comprises a control unit which has a first, non-safety-related control unit for controlling non-safety-related processes with or without a fieldbus connection, none or at least one communication module with a fieldbus connection, and a second, safety-related control unit for controlling safety-related processes (safety control with safe communication, as a separate module or as part of a non-safety-related control system), an internal input/output bus for connecting input/output modules (safe and non-safe modules), an internal coupler bus for connecting communication modules and other modules such as safety control with safe communication, at least one safe HMI, and/or none or at least one standard HMI.

### BRIEF DESCRIPTION OF THE SEVERAL VIEWS OF THE DRAWING(S)

FIG. 1 is a schematic diagram of a control system according to an embodiment of the present disclosure.

FIG. 2 is a schematic of a control system according to a further embodiment of the present disclosure.

### DETAILED DESCRIPTION OF THE INVENTION

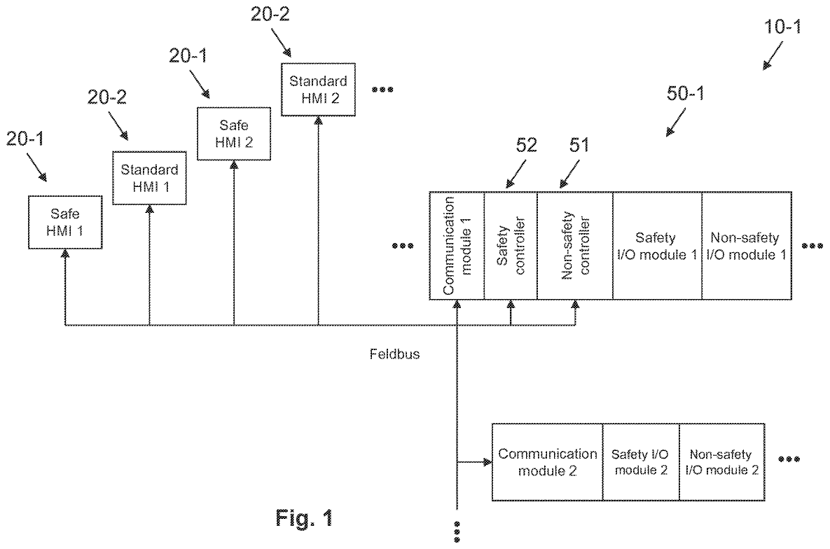

FIG. 1 schematically shows a control system 10-1 comprising at least one safe HMI 20-1 connected to a control unit 50-1 via a fieldbus; the fieldbus can also be used for safe communication, e.g., using a safety profile based on the “black channel” principle (e.g. using PROFIsafe) on the respective fieldbus. A non-secure standard operating unit 20-2 may also be present in the control system 10-1 and connected via the fieldbus. The control unit 50-1 comprises a non-safe control unit 51 and a safe control unit 52. The non-safe control unit 51 is provided for controlling a non-safety-critical process or non-safety critical plant components and executes the non-safety program logic. The safe control unit 52 is provided for controlling a safety-critical process or safety-critical plant components and executes the safe program logic and may have safe communication functions.

An exchange of programs and/or data between the safe control unit 52 and the non-safe control unit 51 may be supported by a predefined interface, such as a dual-port random access memory (RAM). The non-safe control unit 51 can be set up to forward safety telegrams from the safe control unit 52 with safe communication, e.g. via an internal coupler bus and an internal input/output bus to communication modules, if these are connected in the given system setup, or to safety input/output modules using the “black channel” communication principle (see e.g. PROFIsafe).

The safe HMI supports safe communication and may be set up to safely visualize various graphical objects and to provide the status information of these objects to the control unit 50-1, and here in particular to the safe control unit 52 (safety controller of the control system) using safe communication via the fieldbus. In addition, safe commands, for example via the touch screen and associated graphical elements, can be safely monitored by the safe HMI. The commands selected via the touch screen can be securely transmitted via the secure communication to the control unit 50-1, and in particular here to the secure control unit 52 (safety control of the control system). The graphical representation on the screen of the safe man-machine interface, which must be displayed to the operators, can be provided in the control system in a similar way as is the case with non-safe man-machine interfaces, e.g. by Ethernet-based communication via the fieldbus. The safe human-machine interface can be set up to safely monitor the visualized graphical content to be displayed to operators by its internal means, e.g., by a safe, pre-stored graphical object representation in the flash memory of the safe man-machine interface.

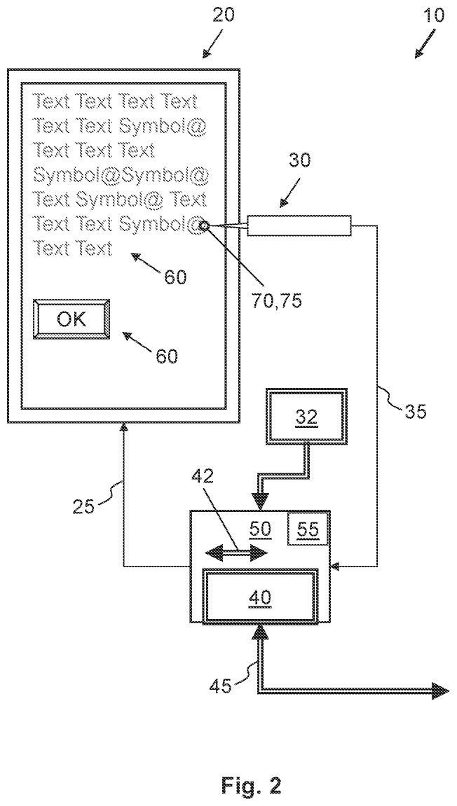

FIG. 2 schematically shows a control system 10 according to a further embodiment. The control system 10 comprises a display device 20 for displaying at least one symbol 60. The symbol 60 may be a text, a (e.g. graphical) symbol, a “button” (e.g. “OK”) and/or another displayed character. The control system 10 further comprises an optical input device 30, which is represented as an electronic pen. The optical input device 30 is configured to detect at least a portion of the symbol 60 displayed by or on the display device 20. For example, as part of the symbol 60 and/or at another location, a check sequence 70 may be displayed on the display device 20. The inspection sequence 70 may include at least one pixel 75. The pixel (or pixels) 75 may thereby flash non-cyclically when subjected to the check sequence 70. For example, an example of a non-cyclic test sequence may be a sequence<1011, pause, 1100, . . . >. Here, “non-cyclic” can mean that a cycle has a minimum length of 10, 100, 1000 or more sequences. The length of the test sequence between pauses may be, for example, 4, 8, 16 bits, or some other length. The pauses may be, for example, 10, 100, 1000 ms, several seconds, or minutes.

The control system 10 further comprises a further input device 32, for example a keyboard. The further input device 32 is redundantly connected to a control device 50. The control device 50 comprises a redundant internal communication system 42. This may be, for example, an internal coupler bus, e.g. for connecting communication modules and other modules such as safety control with secure communication. Furthermore, the control unit 50 comprises a memory 55. A portion of the memory 55 may comprise a binary representation of one or more irrational constants, e.g., a binary representation of it, e, and/or other constants, which may be used, for example, as a basis for generating the test sequence 70.

The control device 50 controls the display device 20 via an interface 25, which transmits the contents of the display on the display device 20 and the test sequence 70. The control device 50 receives signals from the input device 30 via an interface 35. These can be optical signals, but also other signals, such as a “click” with which a button—such as “OK”—can be actuated. The interfaces 25 and 35 are shown to be unidirectional; however, these can also be designed to be bidirectional. In this regard, the control device 50 may connect the various components of the control system 10 in such a way that the output of the control system 10 may be operationally safe (fail-safe). For this purpose, the one control unit 50 can be set up to send the symbol 60 and a test sequence 70 to the display device 20. The symbol 60 and the test sequence 70 are received by the display device 20. The checking sequence 70 is verified, and, if the checking sequence 70 is correctly received, a redundant encoding of the symbol 60 is generated and sent over a redundant network 45.

The output of the control system 10 is via the redundant network or communication system 40 that is set up to send the symbol 60. In this regard, the symbol 60 may also include a sequence of symbols, specific data and/or commands (e.g., from the “OK” button), and/or other information. The data sent via the communication system 40 may be cryptographically encoded.

In the embodiments described herein, the safe HMI (Human Machine Interface) supports safe communication and can be configured to safely visualize various graphical objects and provide the status information of these objects to the safety controller of the control system using safe communication via a fieldbus. In addition, safe commands, e.g., via the touchscreen and associated graphical elements, can be safely monitored by the safe HMI. The selected commands initiated via the touchscreen or other means can be safely transmitted to the safety controller via the safe communication. The graphical representation on the screen of the safe HMI, which must be displayed to the operators, can be provided by the control system in a similar way as is the case with non-safe HMIs, e.g., through Ethernet-based communication via the fieldbus. The safe man-machine interface is able to safely monitor the visualized graphical content to be displayed to the operators by its internal means, e.g., by a safe, pre-stored graphical object representation in the flash memory of the safe man-machine interface.

One aspect relates to a use of a control system as described above and/or below for safely selecting a machine or station, safely changing parameters of the machine or station, sending safe control commands, in particular for activating safety functions, and/or safely visualizing restricted safety areas.

The disclosure describes a safe HMI, in particular a functional safety HMI for a control system. A safe human-machine interface (HMI) is, for example, a control panel with a touch screen, any control panel, or an HMI device, such as a cell phone, PC, etc., capable of meeting functional safety requirements according to relevant functional safety standards by applying appropriate safety-related principles, such as an internal 1oo2 architecture (1oo2: 1 out of 2), internal memory and microprocessor tests, etc. The secure human-machine interface may include at least three key functions; other human-machine interface functions, such as a visualization of non-secure data and/or a selection of non-secure data may also be available on such human-machine interfaces, for example, by means of a fail-safe data input via input means of the HMI, e.g., touch screen, push buttons, etc., and/or fail-safe data visualization with visualization means of the HMI, e.g. LED display, etc.; and/or safe communication with a control system.

The safe HMI may be connected to the control system via a fieldbus, and may in turn include non-safe and safe control parts, both as a modular and as a compact solution, and/or communication means—e.g. separately with a dedicated communication module or on the non-safe control. Centralized and decentralized safety and non-safety I/Os (inputs/outputs) can be used both as a modular and as a compact solution, e.g. on-board non-safety and/or safety controllers. The fieldbus used to connect the safe HMI to the control system can be used not only for standard but also for safe communication, e.g. certified according to functional safety standards IEC 61784-3 and/or other standards. Safety profiles such as PROFIsafe, openSAFETY and/or FSoE (Functional Safety over EtherCAT), etc. can be used on such fieldbuses according to the “black channel” or “black channel” principle. With the aid of safe communication between the safe HMI and the safety controller in the control system, the status of operating elements of the graphical user interface, such as pushbuttons, selector switches, etc., which are visualized on the screen of the safe HMI, can be read safely on the safety controller. This may be necessary, for example, to safely monitor user actions, safety-related events, etc. In addition, secure communication between the safe HMI and the safety controller in the control system can be used to read the status of visualization elements on the safe HMI, e.g., to safely decide whether or not the correct graphical element is currently being displayed to the end user, for example, correct values of speed or position values, an activated machine mode, a selected offset value, etc.

The following exemplary machine or process safety functions can be implemented with an operationally safe input (safe HMI):
Safe selection of machines or stations for remote control;
Safe parameter change, such as rope offset or safely limited speed values, etc.
Safe control commands to activate safety functions such as safely limited speed, etc.
Safe visualization of restricted safety areas for mobile platforms, cranes, etc.

For example, the following principles and methods can be used to implement safe visualization on the safe HMI and meet the requirements of functional safety standards:
Using a safe camera to monitor visible graphical content on the safe HMI. If the visible graphical content does not match the expected content, a safety response can be triggered for the safe HMI.
Use of visualization with polarized screens, e.g. two or more screens. Only when two or more polarized screens are visualized correctly, the final visual content is properly visible to the operators and can be used for functional safety purposes.
Use dynamic patterns on safe HMI screens for graphical objects to avoid static objects with limited diagnostic capabilities.
Use of a test image mode for safe HMIs at regular intervals, e.g. to visualize regular test images for end users as a diagnostic measure.
Using two or more HMI screens as separate objects or as an aggregated safe HMI object to visualize functional safety information. Operators must read the information from the safe HMI as a composite of the two or more screens.

For example, the following principles and methods can be used to implement safe inputs from the safe HMI and to meet the requirements of functional safety standards:
Use of an electronic pen with e.g. light sensor and feedback from the safe HMI surface.
Use of a light, laser or ultrasonic based grid placed in front of the safe HMI surface to safely detect user touch events.
Using an unprotected human finger, or a finger on which electronic components are located, e.g. using special gloves and components built into them, to safely detect user touch events on the safe HMI screen.
Use of optical safety cameras placed near the safe HMI surface to detect touch events. For example, small 2D codes (two-dimensional codes) could be displayed on the screen of the safe human-machine interface, and their coverage by human fingers or other additional objects can be monitored using the optical safety cameras.
Use of safety touch overlays (touch events on safety overlays are monitored by functional safety controllers) on the HMI to realize functional safety functions. The touch overlays can use all known technologies, such as temperature-based or pressure-based, etc.
Use of dynamic elements visualized on the safe HMI, e.g. graphical objects requiring multi-touch activities of operators to trigger safety functions, etc.
Combination of touch events and acoustic signals with further 1oo2 evaluations using touch events and acoustic signals, etc.
Use “virtual” gesture control with virtual reality equipment and safely monitor operator activity or use safe eye tracking to trigger safety functions.
Using an optical keypad to safely monitor touch events for safe HMI instead of touch events on the safe HMI itself.
Using a safe HMI with two or more operating systems running simultaneously on the safe HMI, e.g. using the principle of hardware virtualization, and safe monitoring of touch events using a 1oo2 structure with two different operating systems.
Using two or more HMI screens as separate objects or as an aggregated safe HMI object to trigger functional safety events. It may be envisaged that operators need to touch more than one touchscreen to trigger safety functions.
Use of special hardware-based devices such as acknowledgement buttons, switches, etc. to safely confirm safety actions on the safe HMI.

Advantageously, this can help reduce control costs. Furthermore, more control and visualization elements can be placed on the control panel than on hardware-based control panels to increase the overall safety of the application. In addition, this solution offers easy updating of the layout of the safe HMI screen.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A control system configured for safe input, visualization and/or communication for controlling a machine, the control system comprising:
a display device configured to display at least one symbol;
an optical input device configured to detect, from the display device, at least a portion of the at least one symbol;
a redundant communication system configured to send the at least one symbol to the display device; and
a control unit configured to:
send the at least one symbol and a test sequence to the display device using an interface,
receive from the interface the at least one symbol and the test sequence from the display device,
test at least the test sequence, and
when the control unit determines that the check sequence is correctly received, generate a redundant encoding of the at least one symbol and send the redundantly encoding of the at least one symbol over the redundant network communication system.

2. The control system according to claim 1, wherein the control system is configured for safe selection of a machine or station, for safe parameter change of the machine or station, for sending safe control commands, for activation of safety functions, and/or for safe visualization of restricted safety areas.

3. A control system, comprising:
at least one safe HMI connected to a safe control unit via a fieldbus;
at least one non-secure standard operating unit connected to a non-safe control unit via the fieldbus;
wherein the non-safe control unit controls a non-safety-critical process or plant components and executes non-safety program logic;
wherein the safe control unit controls safety-critical processes or plant components and executes safe program logic; and wherein the safe control unit includes safe communication functions;
wherein, during operation, programs and data is exchanged between the safe control unit and the non-safe control unit via the fieldbus and supported by a predefined interface; and
wherein the non-safe control unit is configured to forward safety telegrams generates by the safe control unit with safe communication;
wherein the safe HMI supports safe communication and is configured to safely visualize various graphical objects and provide status information of the various graphical objects these objects to the safe control unit.

4. The control system of claim 3, further comprising an optical input device connected to the fieldbus, the optical input device visually monitoring graphical content displayed to operators by the at least one safe HMI.

5. A control system, comprising:
a display device configured to display a symbol;
an optical input device configured to detect at least a portion of the symbol displayed on the display device;
wherein the display device is further configured to display a check sequence;
a further input device connected to a control device, the control device including an internal communication system and a memory, the control device being communicatively coupled to the display device and configured to provide at least a portion of the symbol and the check sequence;
an interface, wherein the control device controls the display device via the interface and utilizes the interface to transmit the symbol and the check sequence to the display device;
wherein the control device receives signals from the optical input device via the interface, the signals being indicative of the symbol and the check sequence are displayed on the display device.

6. The control system of claim 5, wherein the control unit is configured to verify the check sequence and, when the control unit verifies the check sequence, the control unit is configured to generate a redundant encoding of the symbol and transmit the same over a redundant network.

7. The control system of claim 6, wherein transmissions of the control unit are cryptographically encoded.
